(19) United States
(12) Patent Application Publication
(10) Pub. No.: US 2007/0093219 A1
(43) Pub. Date: Apr. 26, 2007

(54) Mobile communication terminal

(75) Inventors: Mitsuharu Nakasato, Miyagi (JP); Satoru Watanabe, Kanagawa (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 10/578,998

(22) PCT Filed: Dec. 3, 2004
(86) PCT No.: PCT/JP04/18036

§ 371 Date: May 11, 2006

(30) Foreign Application Priority Data
Dec. 5, 2003 (JP) 2003-407513

(51) Int. Cl. H04B 1/04; H01Q 11/12

(52) U.S. Cl. 455/124; 455/129

(57) ABSTRACT

An object of the invention is to make it possible to maintain the communication quality good without reducing the transmission power of an antenna if a part of a human body comes in contact with or is brought close to the antenna. A transmitter 21 of a mobile communication terminal 1 is made up of a power amplifier 211 and a phase shifter 212 connected between an antenna 10 and the power amplifier 211. The impedance of the antenna 10 in a free space is previously matched to the output load impedance at the time of low output power of the power amplifier 211 and if the head, a finger, etc., touches the antenna 10 and the impedance increases, the phase shifter 212 changes the impedance of the antenna 10 to the output load impedance to increase the output power value of the power amplifier 211.

### TECHNICAL FIELD

This invention relates to a mobile communication terminal such as a mobile phone.

### BACKGROUND ART

In a mobile communication terminal such as a mobile phone, when the head, a finger, etc., of the user comes in contact with or is brought close to an antenna, the impedance of the antenna fluctuates, a mismatch between the impedance of the antenna and the output load impedance of a power amplifier occurs, and the antenna gain may be reduced or the antenna characteristic may be degraded because of radio wave absorption into the human body.

FIG. 6 shows a configuration example of a mobile communication terminal in a related art. This mobile communication terminal in the related art is made up of an antenna 31, a duplexer 32, a radio transmission section 33, a radio reception section 34, a matching section 35, a directional coupling section 36, and a detection section 37. In this configuration, a reflected wave taken out by the directional coupling section 36 is converted into a voltage and the voltage is applied to the matching section 35, whereby the impedance viewing the antenna 31 from the duplexer 32 is kept constant (for example, refer to patent document 1).

In the mobile communication terminal in the related art, when the head, a finger, etc., of the user comes in contact with or is brought close to the antenna, an impedance mismatch is detected and the antenna is matched, whereby reduction in the antenna gain because of the impedance mismatch can be improved; however, degradation of the antenna characteristic because of absorption of an electromagnetic wave into the human body, etc., cannot be improved. Thus, the effect of the human body is received and the transmission power from the antenna may be reduced and the communication quality may be degraded.

Patent document 1: JP-A-7-7357 [paragraphs [0017] to [0019], FIG. 1]

### DISCLOSURE OF THE INVENTION

Problems to be Solved by the Invention

It is therefore an object of the invention to provide a mobile communication terminal that can maintain the communication quality good without reducing the transmission power of an antenna if the head, a finger, etc., of the user comes in contact with or is brought close to the antenna.

Means for Solving the Problems

The mobile communication terminal of the invention is a mobile communication terminal including an antenna for transmitting an electromagnetic wave and a transmitter for supplying a high-frequency transmission signal to the antenna, wherein the transmitter includes a power amplifier for amplifying power of the transmission signal, the power amplifier whose output load impedance changes with impedance of the antenna, and a phase shifter being connected between the power amplifier and the antenna for matching the impedance of the antenna to the output load impedance of the power amplifier.

According to the configuration, if the head, a finger, etc., of the human body of the user, etc., comes in contact with or is brought close to the antenna and the impedance of the antenna shifts from the characteristic impedance of the radio and an impedance mismatch occurs, the output load impedance of the power amplifier is made to change with change in the impedance of the antenna, so that it is made possible to prevent reduction in the transmission power of the antenna and maintain the communication quality good.

As one form of the invention, the above-described mobile communication terminal is also contained wherein the impedance of the antenna in a free space is matched to the output load impedance at the time of low output power of the power amplifier.

According to the configuration, the impedance of the antenna in the free space is previously matched to the output load impedance at the time of low output power of the power amplifier and if the head, a finger, etc., of the human body of the user, etc., comes in contact with or is brought close to the antenna and the impedance of the antenna increases from the impedance in the free space, the output load impedance of the power amplifier is made to change with change in the impedance of the antenna, so that it is made possible to prevent reduction in the transmission power of the antenna and maintain the communication quality good.

As one form of the invention, the above-described mobile communication terminal is also contained wherein when the impedance of the antenna increases, the phase shifter changes the output load impedance of the power amplifier in a direction of impedance at the high output power time.

According to the configuration, if the head, a finger, etc., of the human body of the user, etc., comes in contact with or is brought close to the antenna and the impedance of the antenna increases, the output load impedance of the power amplifier is made to change in the direction of the impedance at the high output power time, whereby the transmission power supplied from the power amplifier to the antenna can be increased, so that it is made possible to prevent reduction in the transmission power and maintain the speech quality good.

In the configuration of the invention, a directional coupler, etc., for detecting an impedance mismatch between the antenna and the power amplifier need not be provided, so that degradation of the communication quality can be prevented without growing the circuit scale.

Advantages of the Invention

According to the invention, there can be provided a mobile communication terminal that can maintain the communication quality good without reducing the transmission power of the antenna if the head, a finger, etc., of the user comes in contact with or is brought close to the antenna.

### BRIEF DESCRIPTION OF THE DRAWINGS

FIG. 1 is a block diagram to show the schematic configuration of a mobile communication terminal to describe an embodiment of the invention;

FIG. 2 is a Smith chart to show equal output power curves of output load impedance of a power amplifier in the mobile communication terminal of the embodiment;

FIG. 3 is a Smith chart to show impedance of an antenna in the mobile communication terminal of the embodiment;

FIG. 4(a) is a Smith chart to describe the antenna impedance in the mobile communication terminal of the embodiment;

FIG. 4(b) is a Smith chart to describe the advantage of a phase shifter in the mobile communication terminal of the embodiment;

FIG. 5 is a drawing to show configuration examples of a phase shifter in the embodiment; and

FIG. 6 is a block diagram to show a configuration example of a mobile communication terminal in a related art.

### DESCRIPTION OF REFERENCE NUMERALS

1 Mobile communication terminal

10 Antenna

20 Radio device

21 Transmitter

22 Receiver

211 Power amplifier

212 Phase shifter

### BEST MODE FOR CARRYING OUT THE INVENTION

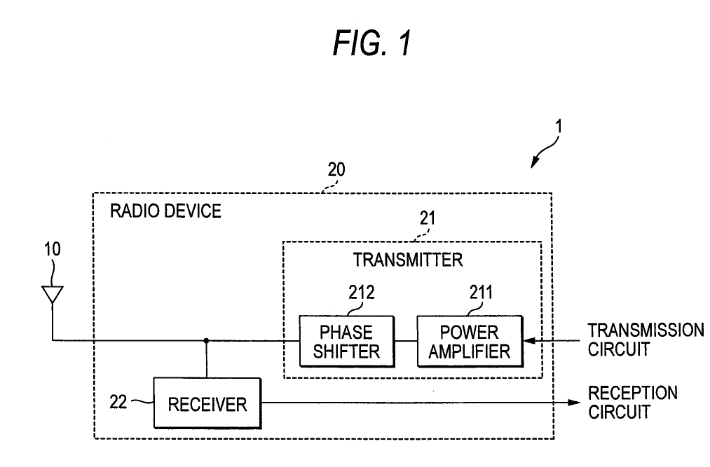

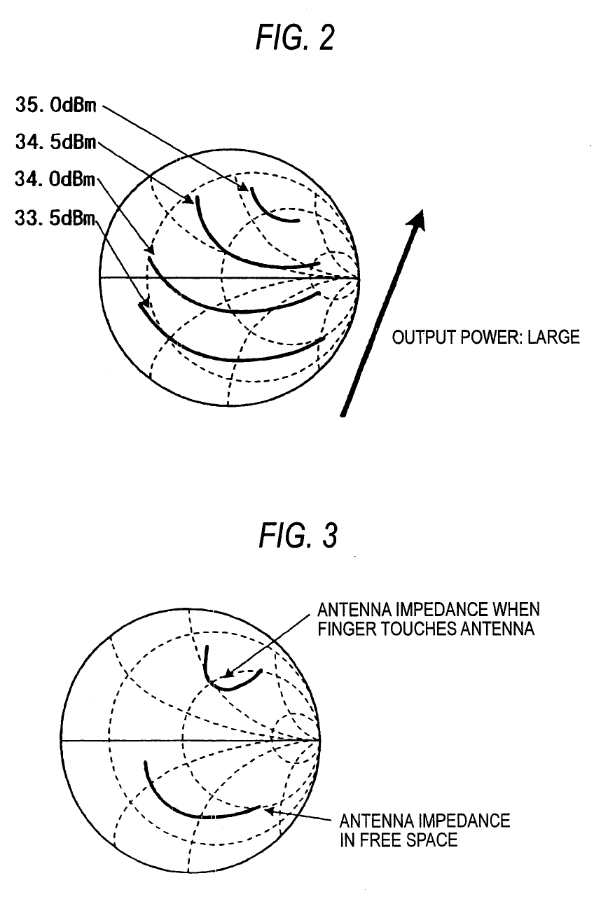

FIG. 1 is a block diagram to show the schematic configuration of a mobile communication terminal to describe an embodiment of the invention, and FIGS. 2 and 3 are Smith charts to describe the operation of the mobile communication terminal of the embodiment. In the embodiment, a configuration example of a mobile communication terminal that can be applied to a mobile phone, etc., used close to the head of a human body is shown.

As shown in FIG. 1, a mobile communication terminal 1 of the embodiment has an antenna 10 for transmitting and receiving an electromagnetic wave and a radio device 20 including a transmitter 21 for generating a transmission high-frequency signal supplied to the antenna 10 and a receiver 22 for processing a high-frequency signal received through the antenna 10. In the radio device 20, the transmitter 21 is connected to a transmission circuit not shown for generating a transmission signal and the receiver 20 is connected to a reception circuit not shown for reproducing a reception signal.

The transmitter 21 is made up of a power amplifier 211 connected to the transmission circuit for amplifying the transmission signal and a phase shifter 212 connected between the antenna 10 and the power amplifier 211. The power amplifier 211 has a function of amplifying the power of the transmission signal sent from the transmission circuit and has the output characteristic as shown in the Smith chart of FIG. 2.

FIG. 2 is a Smith chart to show equal output power curves of the output load impedance of the power amplifier 211, and shows the output load impedance viewing the antenna 10 from the power amplifier 211 for each output power value. In FIG. 2, the expression such as “35.0 dBm” indicates the output power value of the power amplifier 211, and the fact that the equal output power value changes with the output load impedance is represented by equal power curves.

The phase shifter 212 changes the phase for adjusting the impedance of the antenna 10 viewed from the power amplifier 211. If the head, a finger, etc., of the user comes in contact with or is brought close to the antenna 10 and the impedance of the antenna 10 changes, the phase shifter 212 changes the phase so as to provide a predetermined impedance.

The phase shifter 212 can be implemented by connecting an inductive reactance element and a capacitive reactance element in series or in parallel to make up a resonance circuit. It can also be implemented by combining an inductive reactance element and a capacitive reactance element as a T shape or a π shape to make up a phase shifter. Further, it is also possible to make up the phase shifter of strip lines formed on a substrate.

FIG. 3 is a Smith chart to show the impedance of the antenna 10, and shows the impedance in a free space and the impedance when a human body touches the antenna. It is a common practice to match the impedance of the antenna 10 to the characteristic impedance of the radio device 20; in the embodiment, however, the impedance of the antenna 10 in a free space is set so as to almost match the output load impedance when the output power of the power amplifier 211 shown in FIG. 2 is small, as shown in FIG. 3. As the phase shifter 212 is provided, setting is made so that the impedance when the head, a finger, etc., of a human body touches the antenna almost matches the output load impedance when the output power of the power amplifier 211 shown in FIG. 2 is large. At this time, parts of an isolator, etc., to keep the output load impedance of the power amplifier 211 constant are not provided between the power amplifier 211 and the antenna 10, so that when the impedance of the antenna 10 changes, the output load impedance of the power amplifier 211 also changes.

According to the described configuration, when the head, a finger, etc., of the user comes in contact with or is brought close to the antenna 10 and the impedance of the antenna 10 increases from the impedance in the free space, the output load impedance of the power amplifier 211 changes so as to become the output load impedance when the output power is high. Therefore, when the head, a finger, etc., of the user comes in contact with or is brought close to the antenna 10, it is made possible to increase the transmission power supplied to the antenna 10 for maintaining good speech quality.

Next, the operation of the mobile communication terminal 1 having the configuration described above when the head, a finger, etc., of the user comes in contact with or is brought close to the antenna 10 at the transmission time will be discussed.

When the head, a finger, etc., of the user comes in contact with or is brought close to the antenna 10, the resonance frequency of the antenna 10 lowers and the impedance of the antenna 10 increases and makes a transition in a given direction. Since the transmitter 21 of the embodiment is not provided with parts of an isolator, etc., to keep the output load impedance of the power amplifier 211 constant, change in the impedance of the antenna 10 has an effect on the power amplifier 211 through the phase shift circuit 212 and the output load impedance of the power amplifier 211 changes.

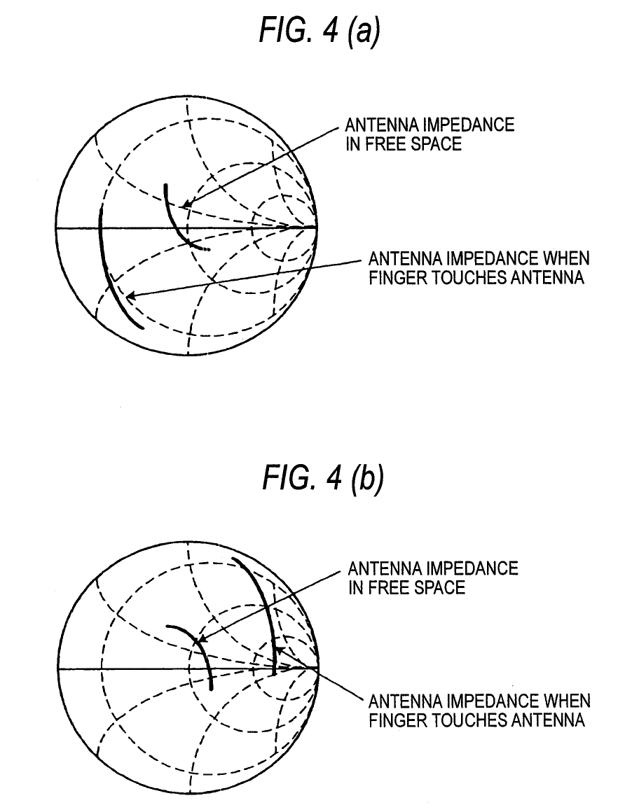

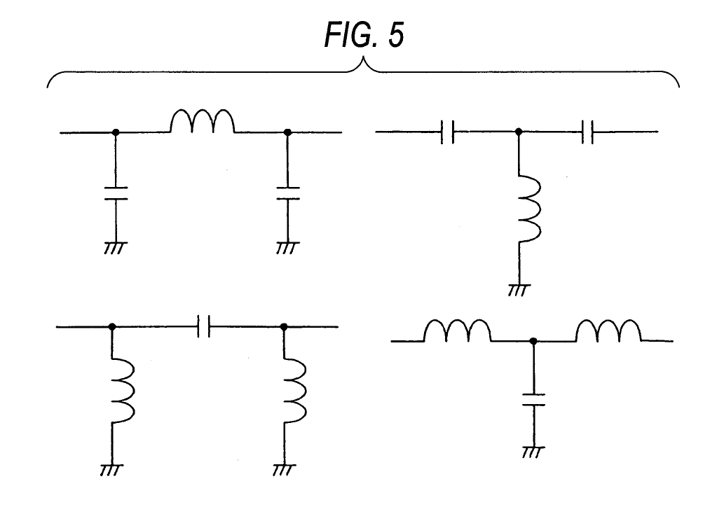

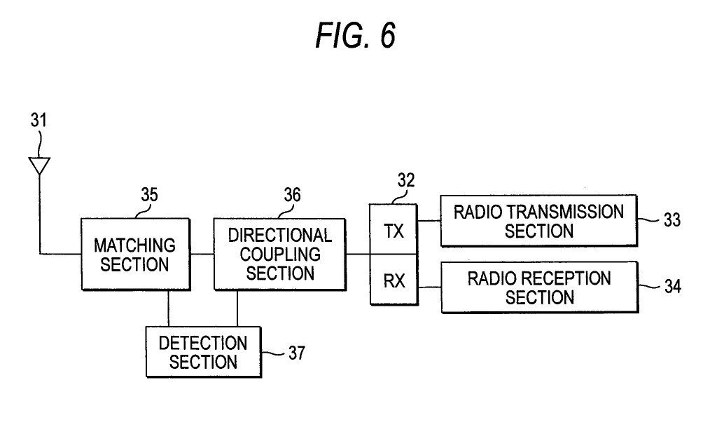

At this time, the phase is changed based on a feeder line, etc., of the antenna 10 and therefore the output load impedance does not necessarily matches the high output load impedance of the power amplifier 211. For example, as in FIG. 4(a), if a finger touches the antenna 10, when the output load impedance becomes the low output load impedance of the power amplifier 211, the power transmitted from the antenna 10 also reduces. Then, to solve this problem, the phase shifter 212 is provided in the embodiment. When the output power value of the power amplifier 211 increases, the phase shifter 212 functions so as to match the impedance of the antenna 10 viewed from the power amplifier 211 to the output load impedance. For example, in FIG. 4(a), a 180-degree phase shifter is adopted, whereby the output load impedance becomes as in FIG. 4(b) and when a finger touches the antenna, the output load impedance becomes the high output load impedance. Consequently, the output power value of the power amplifier 211 increases and the transmission power of the antenna 10 increases. FIG. 5 shows configuration examples of the phase shifter. FIG. 5 shows configuration examples each based on a lumped constant, but the phase shifter may use a microstrip line or may be made up of a microstrip line and a lumped constant.

Thus, if the head, a finger, etc., of the user touches the antenna 10 and an impedance mismatch occurs and the efficiency of the antenna 10 is degraded, the output power value of the power amplifier 211 increases, so that reduction in the power transmitted from the antenna 10 can be minimized and degradation of the speech quality can be prevented.

As described above, in the embodiment, the transmitter 21 of the mobile communication terminal 1 includes the power amplifier 211 connected to the transmission circuit not shown and the phase shifter 212 connected between the antenna 10 and the power amplifier 211. With the phase shifter 212, the impedance of the antenna 10 in the free space is previously matched to the output load impedance at the time of low output power of the power amplifier 211 and if the impedance of the antenna 10 increases, the impedance changes to the output load impedance to increase the output power value of the power amplifier 211.

According to the configuration, if the head, a finger, etc., of the user comes in contact with or is brought close to the antenna 10 in a conversation state, etc., and the antenna efficiency is degraded, the impedance of the antenna 10 viewed from the power amplifier 211 changes to the output load impedance at the high output time and the output power value of the power amplifier 211 can be increased. Accordingly, reduction in the power transmitted from the antenna 10 can be minimized and it is made possible to prevent degradation of the speech quality.

While the invention has been described in detail with reference to the specific embodiment, it will be obvious to those skilled in the art that various changes and modifications can be made without departing from the spirit and the scope of the invention.

The present application is based on Japanese Patent, Application No. 2003-407513 filed on Dec. 5, 2003, which is incorporated herein by reference.

### INDUSTRIAL APPLICABILITY

The invention has the advantage that if the head, a finger, etc., of the user comes in contact with or is brought close to the antenna, it is made possible to maintain the communication quality good without reducing the transmission power of the antenna, and is useful for a mobile communication terminal such as a mobile phone or the like.

1. A mobile communication terminal, comprising:
an antenna that transmits an electromagnetic wave; and
a transmitter that supplies a high-frequency transmission signal to the antenna,
wherein the transmitter includes:
a power amplifier that amplifies power of the transmission signal, and an output load impedance of the power amplifier being changed on the basis of an impedance of the antenna; and
a phase shifter connected between the power amplifier and the antenna for matching the impedance of the antenna to the output load impedance of the power amplifier.

2. The mobile communication terminal as set forth in claim 1, wherein the impedance of the antenna in a free space is matched to the output load impedance at the time of low output power of the power amplifier.

3. The mobile communication terminal as set forth in claim 1, wherein when the impedance of the antenna increases, the phase shifter changes the output load impedance of the power amplifier in a direction of impedance at the high output power time.
